(19) United States
(12) Patent Application Publication
(10) Pub. No.: US 2012/0132233 A1
(43) Pub. Date: May 31, 2012

(54) Animal Waste Removal Device

(76) Inventor: Lawrence Orubor, Calgary (CA)

(21) Appl. No.: 13/305,995

(22) Filed: Nov. 29, 2011

Related U.S. Application Data
(60) Provisional application No. 61/418,247, filed on Nov. 30, 2010.

(51) Int. Cl. B08B 3/00

(52) U.S. Cl. 134/94.1

(57) ABSTRACT

A pet waste removal device including an elongated hand held boom having an open bottom shield disposed at a bottom end of the boom for positioning over a pile of animal waste. A motor driven agitator is disposed within the shield and driven by a motor to rotate between a counterclockwise and a clockwise rotation to mechanically break up pet waste. Fluid jet nozzles are supplied water via a garden hose connection and are arranged to direct water jets into the shield to wash away the pet waste as it is broken up by the agitator. A chemical dispenser for dispensing a chemical solution can also be provided.

### FIELD OF THE INVENTION

The present invention relates generally to pet waste removal devices, and more particularly, relating to a pet waste removal and disinfecting device for the removal of solid pet waste from a surface by a combination of powered agitation and treatment solution jet action.

### BACKGROUND OF THE INVENTION

Animal waste, particularly raw fecal material from dogs and other household pets are smelly and consist largely of numerous disease causing pathogens that pose potential health risks to pets and humans exposed to them. These disease causing pathogens found in fecal material also contaminated our soil, water and food grown in their vicinity. It is believed, the enormous volume of uncontrolled animal waste produced each year has significant impact on public health and the environment. Particularly, in the presence of accumulated waste in places such as backyards, public and private play grounds, including off leash parks. The presence of animal waste is considered an eye sore and a nuisance which must be eliminated.

### SUMMARY OF THE INVENTION

The preferred embodiments of the present invention addresses this need by providing a pet waste removal device that has an improved construction affording a combination of powered agitation and treatment solution flushing action to dispose of pet waste. There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there is illustrated embodiments of the invention.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 is a diagrammatic side view of a first embodiment of an animal waste removal device constructed in accordance with the principles of the present invention;

FIG. 2 is a diagrammatic bottom view of a material agitator embodied in the animal waste removal device;

FIG. 3 is a diagrammatic side view of the animal waste removal device of FIG. 1 illustrated in a mode of operation wherein an external jet of fluid is dispensed and directed at a deposit of animal waste to either soften the waste for further treatment or to flush the waste from a surface;

FIG. 4 is a diagrammatic side view of the animal waste removal device of FIG. 1 illustrated in a mode of operation wherein animal waste is being acted upon internal fluid jets and the agitator to break-up and dissolve the waste;

FIG. 5 is a diagrammatic side view of the animal waste removal device of FIG. 1 illustrated in a self-clean mode of operation wherein debris is flushed from the interior and exterior surfaces of the working or cleaning head of the removal device;

FIG. 6 is a diagrammatic side view of the animal waste removal device and a charging and storage dock;

FIG. 7 is a diagrammatic side view of an alternative embodiment of the removal device, wherein a plurality of nozzles may be further selected for the dispensing of treatment solution or fresh water;

FIG. 8 is a diagrammatic side view of an alternative embodiment of the removal device including a manual operated nozzle selector valve;

FIG. 9 is a diagrammatic side view of an alternative embodiment of the removal device in a simplified embodiment and include a power cord for connecting the device to a source of line-power;

FIG. 10 is a diagrammatic side view of an alternative embodiment of the removal device include a self-container source of fresh water and a concentrated chemical dispenser;

FIG. 11 is a diagrammatic side view of an alternative embodiment of the removal device including a reservoir containing a quantity of pre-mixed treatment solution;

FIG. 12 is a diagrammatic side view of yet an additional alternative embodiment of the removal device including a dual chemical dispenser configuration;

FIG. 13 is a diagrammatic side view of yet an additional alternative embodiment of the removal device including a telescopic handle;

FIG. 14 is a diagrammatic side view of an alternative embodiment of the embodiment of FIG. 13;

FIG. 15 is a diagrammatic side view of an alternative embodiment of the embodiment of FIGS. 13 and 14;

FIG. 16 is a diagrammatic side view of yet another alternative embodiment of the removal device including a retractable animal leash;

FIG. 17 is a diagrammatic side view of the embodiment of FIG. 16; and

FIG. 18 is a diagrammatic side view of the embodiment of FIG. 16.

### DETAILED DESCRIPTION OF THE INVENTION

In this description, references to “one embodiment” or “an embodiment” mean that the featuring being referred to is included in at least one embodiment of the invention. Moreover, separate references to “one embodiment” in this description do not necessarily refer to the same embodiment. Illustrated embodiments are not mutually exclusive, unless so stated and except as will be readily apparent to those of ordinary skill in the art. Thus, the invention may include any variety of combinations and/or integrations of the embodiments described herein.

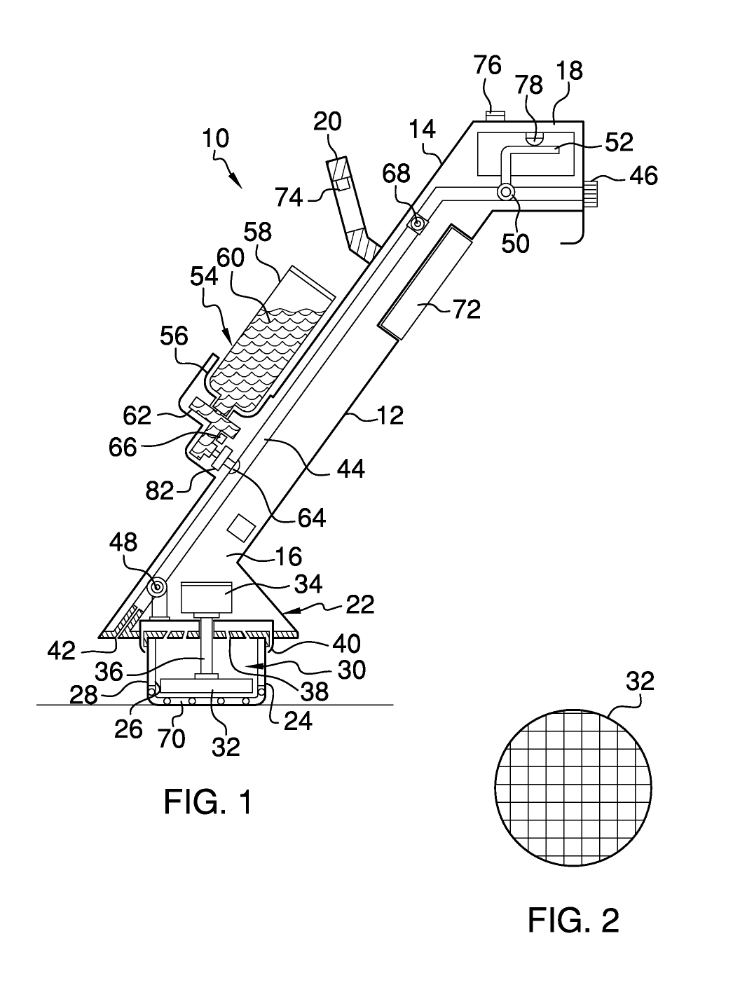

In FIG. 1, there is diagrammatically illustrated a first embodiment of an animal waste removal device 10 of the present invention. Device 10 includes an elongated hand-held boom 12 having an upper end 14 and a lower end 16. A first control handle 18 is disposed at end 14 and a second control handle 20 is disposed at a forward position along the boom 12 from handle 18. In operating the device 10, a user grasps handle 18 with one hand and with the other hand grasps handle 20.

A cleaning head 22 is disposed at end 16 of the boom 12. The cleaning head includes a downwardly depending plenum 24. The plenum 24 has an open bottom 26 and a sidewall 28 that defines an interior space 30. The interior space 30 is accessed through the open bottom 26. A material agitator 32 is disposed within the interior space 30. An electric motor 34 supported by the boom 12 is operatively connected to the agitator 32 by shaft 36. The electric motor 34 is operatively connected to the agitator 32 such that operation of the electric motor drives the agitator in an alternating clockwise and counterclockwise rotation. As will be described in further detail below, the plenum 24 is positioned over a deposit of animal waste and serves to shield the operator from animal waste being churned and broken-up by the agitator 32 acting upon the animal waste.

A plate 70 of open mesh grating extends across the open bottom 26 of plenum 24. The open mesh grating plate 70 prevents large solid objects from entering the interior space 30 of the plenum 24 that could possibly damage the agitator 32. The mesh size of plate 70 is sufficient to permit the passage of animal waste into the interior space 30 without mashing the pet waste into the ground. Plate 70 can be removably attached to the plenum 24 by mutual engagement between periphery of the plate and sidewall 28 of the plenum.

The cleaning head 22 further includes fluid nozzles 38, 40 and 42. Fluid nozzles 38 are disposed may be disposed within the plenum 24 and arranged to direct fluid jets towards the open bottom 26 and across the agitator 32. Fluid nozzles 38 can be arranged to provide a crossing pattern of jets to impinge upon the animal waste at different angles to further aid in breaking up the waste and/or directed towards the interior surface of sidewall 28 to flush the interior surface free of waste. Fluid nozzles 40 are disposed and arranged to direct fluid jets towards the exterior surface of sidewall 28 to flush the exterior surface free of waste. Fluid nozzle 42 is directed outwardly from end 16 and away from the plenum 24 to provide a fluid jet that may be used to flush a ground surface.

Fluid nozzles 38, 40 and 42 are connected to a fluid passage 44 to dispense fluid flowing through fluid passage 44. A hose coupling 46 permits connecting the fluid passage 44 to an external hose, such as a garden hose connected to a water spigot to receive a flow of pressurized water. Fluid passage 44 may be integrally formed with boom 12, or may be a ridge or flexible pipe or hose extending along and within the interior or along the exterior of boom 12. An electrically operated two-way valve 48 selectively connects fluid nozzles 38 and 40 or fluid nozzle 42 to the fluid passage 44.

A main supply valve 50 is positioned across the fluid passage 44 upstream from valve 48 and is operated to control the flow of pressurized fluid through the fluid passage 44 from the source of pressurized fluid, e.g. a garden hose connected to coupling 46. Main supply valve 50 may be a normal-closed valve and spring biased into the closed position. A trigger 52 may be operatively connected to valve 50, and is positioned to be graspable by the fingers of a user holding handle 18, whereby valve 50 may be operated by squeezing ones hand.

Device 10 further includes a chemical dispenser 54. Chemical dispenser 54 includes a cradle 56 disposed along boom 12 and configured to removably receive and retain a container 58 of concentrated chemical solution 60. A fluid accumulator 62 is fluidically connected to the container 58 to receive therein chemical solution 60 when the container 58 is received by the cradle. The container 58 may be fitted with a membrane seal that is pierced by a tube extending from the accumulator 62 to fluidically connect the container and accumulator. Alternatively, a cooperative valve system could be used to fluidically connect the container 58 and the fluid accumulator 62 while preventing spilling of the chemical solution 60 from the container during insertion and removal of the container from the cradle. Essentially, chemical solution 60 within the container 58 flows under the force of gravity into the fluid accumulator 62 when the container is received by the cradle 56 to provide a continuous supply of chemical solution from the container to the accumulator. When the container becomes empty the container is replaced with a full container.

A siphon tube 64 extends from the accumulator 62 and connects to the fluid passage 44 such that fluid flowing through fluid passage 44 and across the siphon tube draws chemical solution 60 within the fluid accumulator into the fluid passage 44 where it is admix with the fluid flowing therethrough. An electrically operated chemical supply valve 82 is disposed across the siphon tube 64 or between the accumulator 62 and fluid passage 44 and is operated to control the flow of chemical solution 60 from the accumulator 62 into the fluid passage 44.

A fluid sensor 66 may be provided to detect the presence of chemical solution 60 within the accumulator 62. Further, an electrically operated cut-off valve 68 may be disposed across the fluid passage 44 at a position immediately down stream of the main supply valve 50. Cut-off 68 is operated to permit the flow of fluid through passage 44 when the fluid sensor 66 detects chemical solution 60 within the accumulator and is operated to prevent the flow of fluid through passage 44 when the fluid sensor does not detect chemical solution within the accumulator. Further, the electrical motor 34 may be prevented from operating when the fluid sensor 66 fails to detect chemical solution 60 within the accumulator 62. To this end, the device 10 is prevented from being operated unless there is chemical solution 60 present so as to ensure proper removal of the animal waste and surface sanitization.

The device 10 further includes a power supply, such as a rechargeable battery pack 72 to provide electrical power to the electrical components of the device. The battery pack 72 can be removably received and retained by the boom 12.

In an aspect, an electrical switch such as switch 74 located on handle 20 is operated to selectively connect diverter valve 48 with the power supply 72 to operate valve 48 from its normal position where the fluid passage 44 is connected to nozzles 38 and 40 to its second operating position where the fluid passage 44 is connected to nozzle 42. In an aspect, an electrical switch such as switch 76 located on approximate handle 18 is operated to selectively connect chemical supply valve 82 with the power supply 72 to operate the chemical supply valve 82 from its normally closed position where chemical solution is prevented from flow into or through the siphon tube 64 to its open position where chemical solution may flow into or through the siphon tube and into flow passage 44. In an aspect, an electrical switch such as switch 78 located on handle 18 and activated by trigger 52 in cooperation with switch 74 connects the electrical motor 34 with the power supply 72 to drive the agitator 32. In the instance where switch 74 is activated, the electrical motor 34 is not connected to the power supply through operation of switch 78.

In FIG. 2, there is diagrammatically illustrated a bottom view of agitator 32. Agitator 32 includes an open mesh grid with openings extending vertically through the grid. In operation, pet waste is mechanically broken upon into smaller bits by a clockwise-counterclockwise rotational action of the agitator 32. Jets of treatment solution from nozzles 38 are free to pass through openings the openings of the open mesh grid to sanitize and flush waste from the openings and to further churn and breakup the waste.

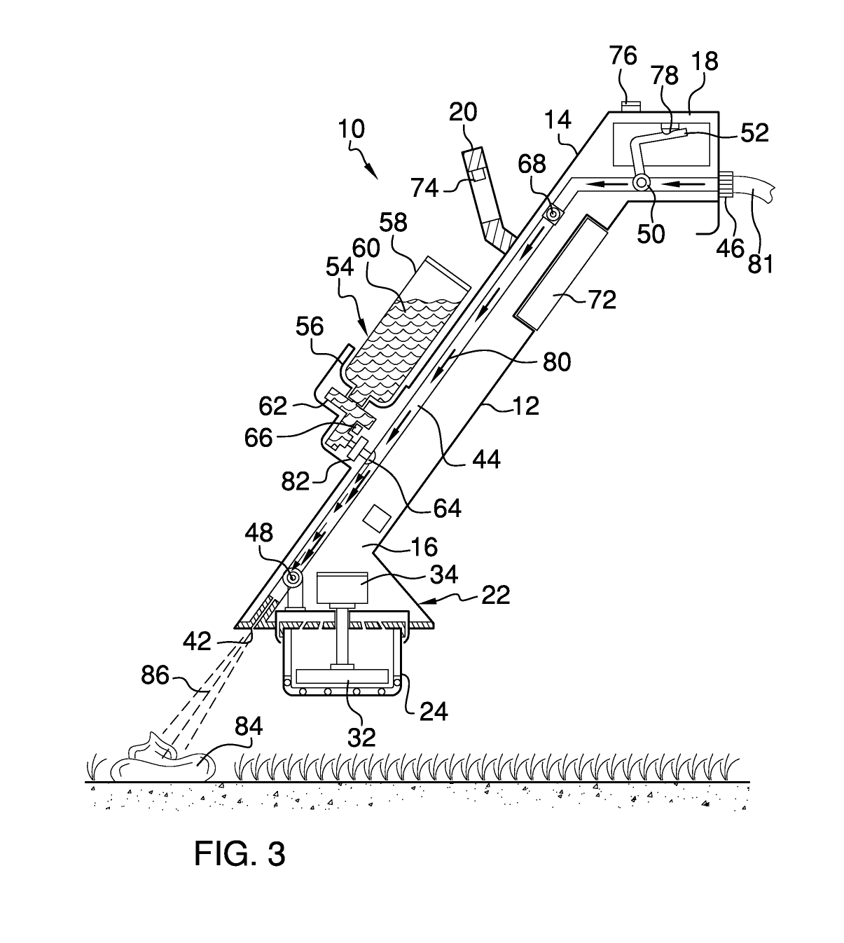

In FIGS. 3 through 5, there is diagrammatically illustrated the device 10 being operated in several different modes of operation. Initially, in each of these separate modes of operation, a container 58 containing a supply of chemical solution 60 is received by the cradle 56 and the accumulator 62 is filled with the chemical solution. The fluid sensor 66 detects the chemical solution, and accordingly, the cut-off valve 68 is operated to the open position thereby permitting fluid to flow through the passage 44. Additionally, in each of these modes of operation, a hose 81 that is connected to a supply of pressurized water is connected to hose coupling 46, thereby supplying passage 44 with the pressurized water 80.

With particular reference to FIG. 3, the device 10 is being operated to dispense a jet of fluid 86, such as fresh water or treatment solution, onto a targeted deposit of animal waste 84. This mode of operation is particularly useful for pre-treating dried animal waste to soften the waste prior to using the agitator 32. This mode of operation is also useful for treating and removing bird droppings from a surface. Further, this mode of operation is useful for flushing treated and dissolved waste from a non-porous surface, such as pavements, sidewalks and the like.

In this mode of operation, an operator grasping handles 18 and 20 squeezes trigger 52 and thus opening main supply valve 50 thereby allowing pressurized water to flow into passage 44. Switch 74, on handle 20, is activated thus precluding connection between the electrical motor 34 and the power supply 72, and further connecting the diverter valve 48 and the power supply 72. With the diverter valve 48 receiving electrical power from the power supply, the valve is operated to its second position wherein nozzle 42 is fluidically connected to passage 44 and the water 80 is dispensed from nozzle 42. Chemical concentrate 60 may be admixed with the flow of water through the passage 44 to dispensing treatment solution by activating switch 76. Activation of switch 76 connects the chemical supply valve 82 and the power supply 72, and thus the chemical supply valve operated to the open position establishing a fluid flow of chemical solution from the accumulator 62 through the siphon tube and into passage 44. In passage 44, the chemical solution is admixed with the water flowing therethrough and thus forming a treatment solution.

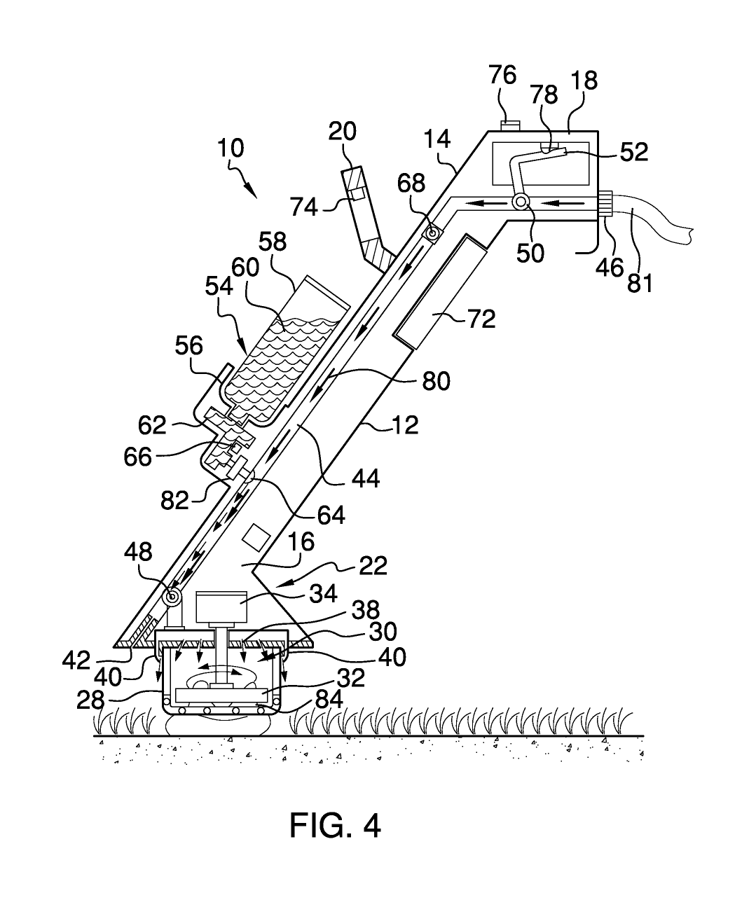

With particular reference to FIG. 4, the device 10 is diagrammatically illustrated operating in another mode of operation wherein the animal waste 84 is being broken-up and dissolved by a combination of the operation of the agitator 32 and fluid jets. Here the operator, grasping handles 18 and 20 positions the plenum 24 over a deposit of animal waste 84 with the animal waste being received within the interior space 30 of the plenum. The operator squeezes trigger 52, opening main supply valve 50 allowing pressurized water to flow into passage 44. Here, switch 74 is not activated, thus the electrical motor 34 and chemical supply valve 82 is connected to the power supply 72 by operation of switch 78, which is activated upon squeezing trigger 52. Accordingly, the electric motor 34 receives electrical power from the power supply 72, and thus drives the agitator 32. Further, because switch 74 is not activated, the diverter valve 48 remains in its normal position connecting nozzles 38 and 40 to the fluid passage 44. Chemical concentrate 60 is admixed with the flow of water through the passage 44 by activating switch 78. Activation of switch 78 connects the chemical supply valve 82 and the power supply 72, and thus the chemical supply valve is operated to the open position establishing a fluid flow of chemical solution from the accumulator 62 through the siphon tube and into passage 44. In passage 44, the chemical solution is admixed with the water flowing therethrough and thus forming a treatment solution. The treatment solution is dispensed through nozzles 38 in fluid jets that impinge on the interior surface of sidewall 28, the agitator 32 and the animal waste 84. The treatment solution is also dispensed through nozzles 40 in fluid jets that impinge on the exterior surface of sidewall 28, thereby flushing debris therefrom. The combined action of the agitator 32 and the fluid jets break-up and dissolved the animal waste 84. The plenum 24 shields the operator from splatter during operation.

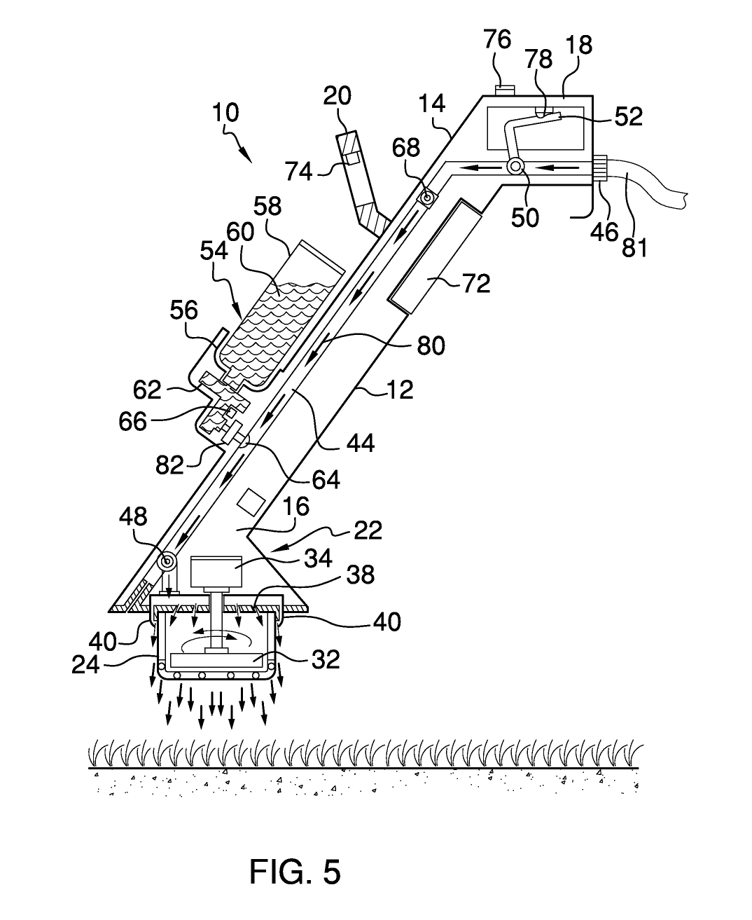

With particular reference to FIG. 5, the device 10 is diagrammatically illustrated operating in a self-cleaning mode of operation where the cleaning head 22 is flushed and sanitized and thus permit storage of the device for later use. To initiate this mode of operation, from the prior mode of operation, the operator simply operates switch 76 to disconnect the chemical supply valve 82 from the power supply 72, while maintaining activation of trigger 52. Accordingly, freshwater is dispensed from nozzles 38 and 40 while the electric motor 34 continues to drive the agitator 32. The discharging of freshwater cleans the interior and exterior surfaces of the sidewall 28, the protective grate 70 and the agitator 32. Once fully cleaned, the device 10 is ready for storage until the next use.

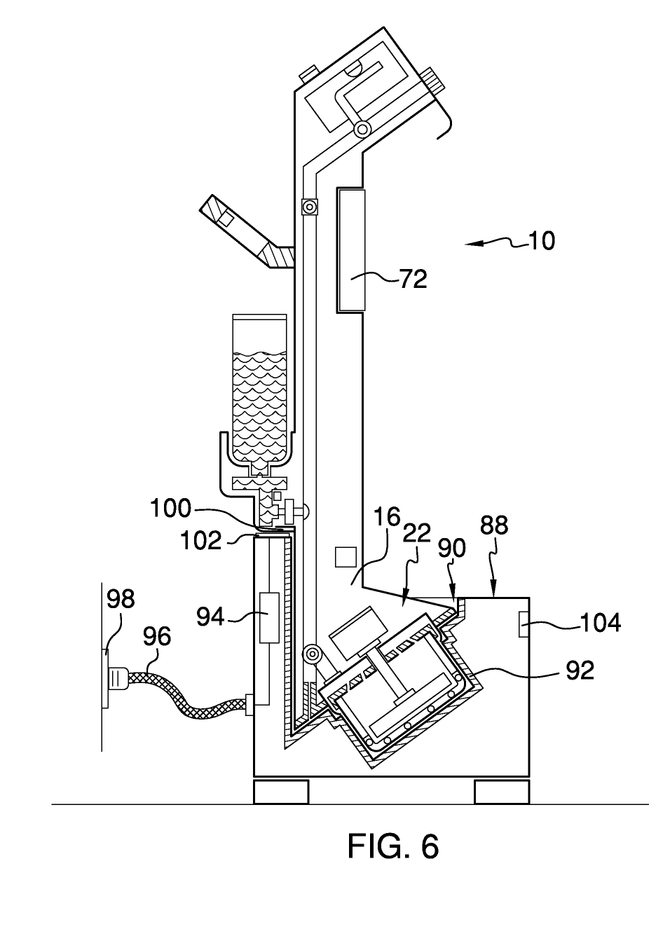

In FIG. 6, there is diagrammatically illustrated the device 10 received by a storage dock 88. Storage dock 88 includes an opening 90 that is configured to receive and hold the device 10 for storage. Particularly, the opening 90 is configured to receive the lower end 16 and the cleaning head 22 therein. The opening 90 may be fitted with a removable liner 92 that can either be disposable or washable. In an aspect, storage dock 88 may also serve as a charging dock to charge the power supply 72. Particularly, storage dock 88 may include a charging circuit 94 configured to receive electrical power via power cord 96 that is plugged into a house hold electrical receptacle 98. Electrical contacts 100 and 102 disposed on the device 10 and storage dock 88, respectively, provide a electrical connection between the charging circuit 94 and the power supply 72. Further, charging circuit 94 may include a charging status indicator 104 disposed on the storage dock 88 to be visually inspected by an operator.

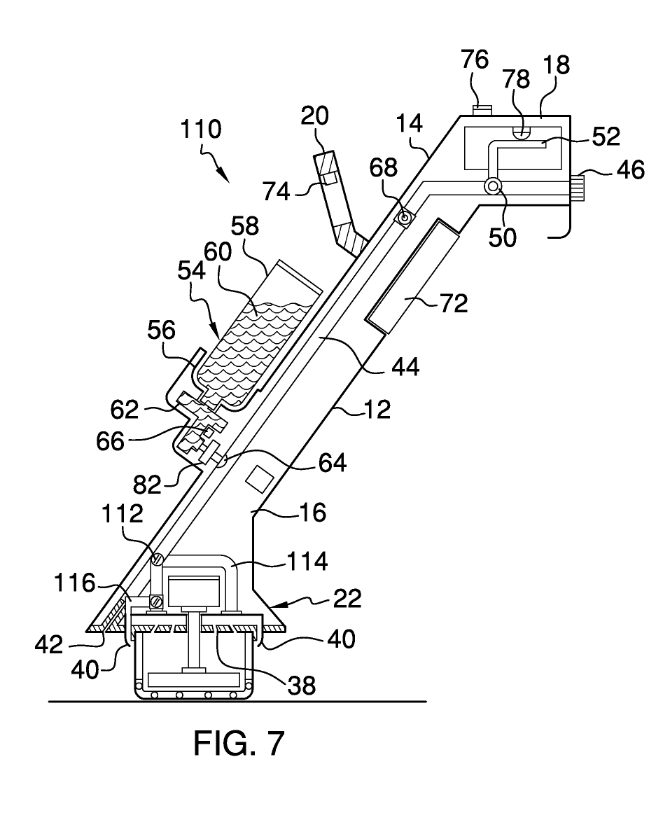

Alternative embodiments of the animal waste removal device are possible. In FIG. 7, there is diagrammatically illustrated a second embodiment 110 of the invention, wherein same reference numbers refer to similar parts. In the first embodiment 10, nozzles 38 and 40 were connected to a common fluid passage to diverter valve 48. In the second embodiment 110, the diverter valve 48 is replaced with a three-position valve 112, nozzles 38 are connected to fluid passage 114 and nozzles 40 are connected to a fluid passage 116. Fluid passages 114 and 116 are each connected to valve 112. Valve 112 is operable to selectively establish a fluid flow between nozzle 42 and fluid passage 44, fluid passage 114 (connected to nozzles 38) and fluid passage 44, fluid passage 116 (connected to nozzles 40) and fluid passage 44 or both fluid passages 114 and 116 to fluid passage 44. To this end, an operator may selectively discharge fluid through nozzle 42, nozzles 38, nozzles 40 or both nozzles 38 and 40 as desired. A skilled artisan will readily appreciate and understand the operation of this embodiment taken in consideration with the above described operation of the first embodiment.

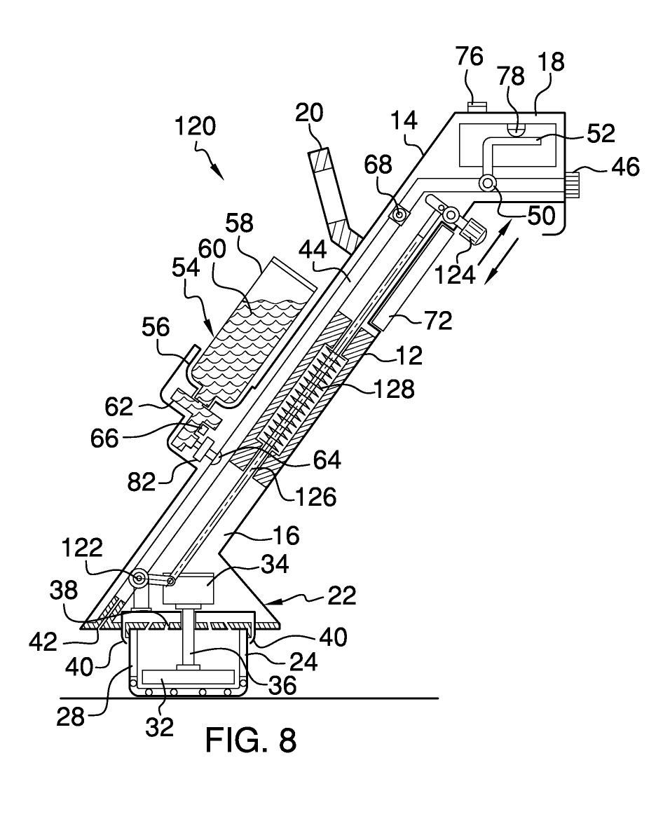

In FIG. 8, there is diagrammatically illustrated a third embodiment 120 of the invention, wherein same reference numbers refer to similar parts. In the first embodiment 10, diverter valve 48 is an electrically operated valve that is operated by being connected to the power supply 72 by operation of switch 74. In the third embodiment, electrically operated diverter valve 48 is replaced by a manually operated valve 122. Valve 122 is operated by control lever 124 that is connected to valve 122 by a connecting rod 126. Control lever 124 is biased by spring 128 into a first position wherein valve 122 is positioned to establish fluid flow between passage 44 and nozzles 38 and 40. Operation of the control lever 124 against the bias operates valve 122 into a second position where fluid flow is established between passage 44 and nozzle 42 and precluded from nozzles 38 and 40 and passage 44. A skilled artisan will readily appreciate and understand the operation of this embodiment taken in consideration with the above described operation of the first embodiment.

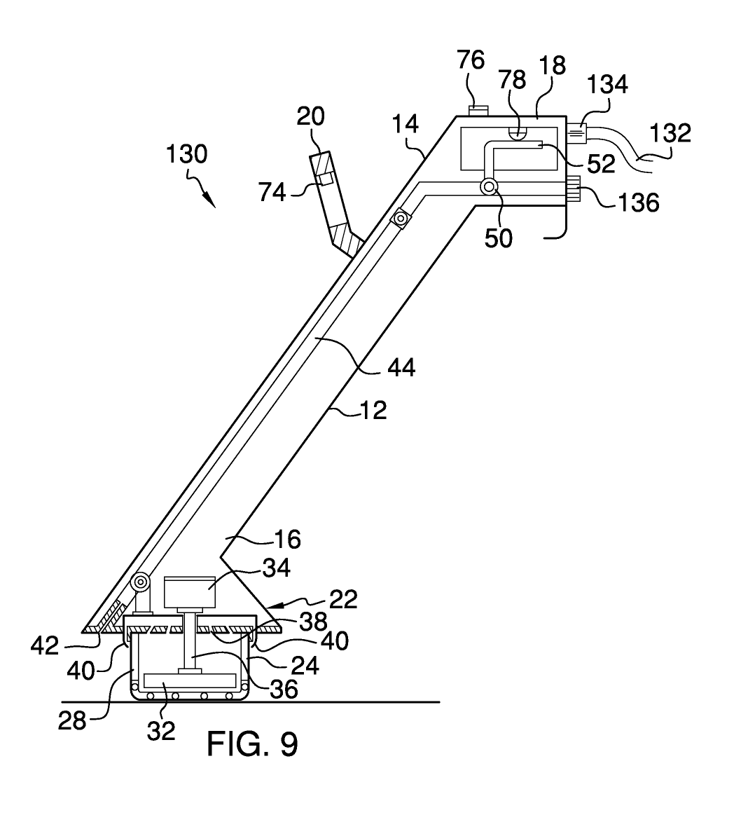

In FIG. 9, there is diagrammatically illustrated a fourth embodiment 130 of the invention, wherein same reference numbers refer to similar parts. The fourth embodiment 130 is somewhat of a simplified embodiment, wherein the chemical dispenser 54 and associated components are eliminated. Further, the onboard power supply 72 is replaced in favor of line-power that is connected to device 130 via electrical power cord 132 to provide electrical power to the various electrical components of the device. Power cord 132 may be removably connected to the device 130 by a cooperating socket 134. In another aspect, coupling 46 could be replaced by a safety hose coupling 136 that is configured to couple to only a specified hose that may be connected to a supply of pressurized treatment solution. A skilled artisan will readily appreciate and understand the operation of this embodiment taken in consideration with the above described operation of the first embodiment.

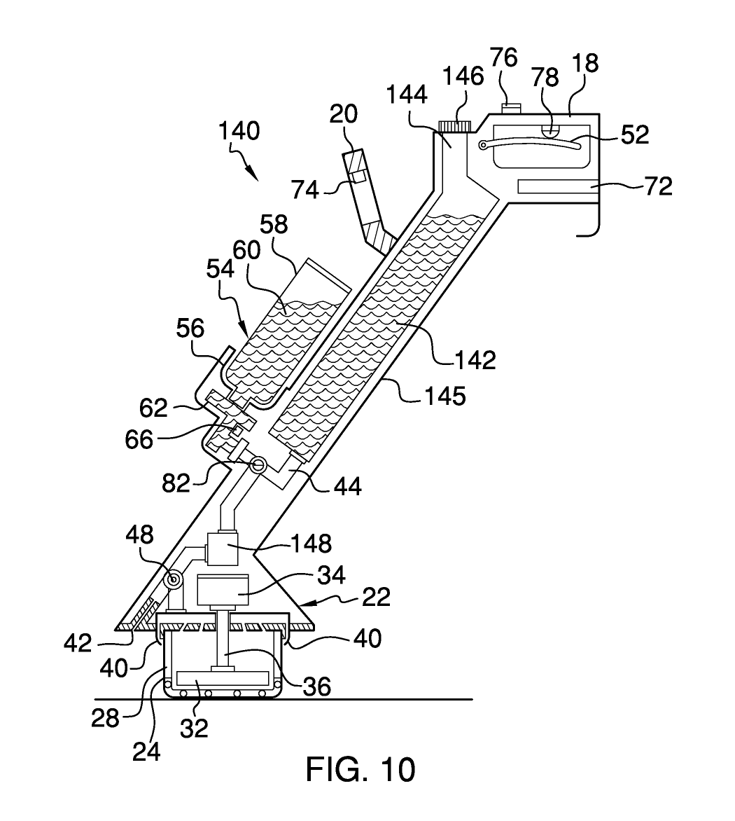

In FIG. 10, there is diagrammatically illustrated a fifth embodiment 140 of the invention, wherein same reference numbers refer to similar parts. Device 140 is completely mobile and does not require connection to a separate source of pressurized water or a source of electrical power. A freshwater reservoir 142 is provided and may be housed in boom 145. The reservoir 142 includes an opening 144 for filling and a removable lid 146 for sealing opening 144. The reservoir 142 is fluidically connected to passage 44 and an electrically operated pump 148 is connected to fluid passage 44 to pump the freshwater contained therein through passage 44. The pump 148 is connected to power supply 72 by operation of electrical switch electrical switch 78. A skilled artisan will readily appreciate and understand the operation of this embodiment taken in consideration with the above described operation of the first embodiment.

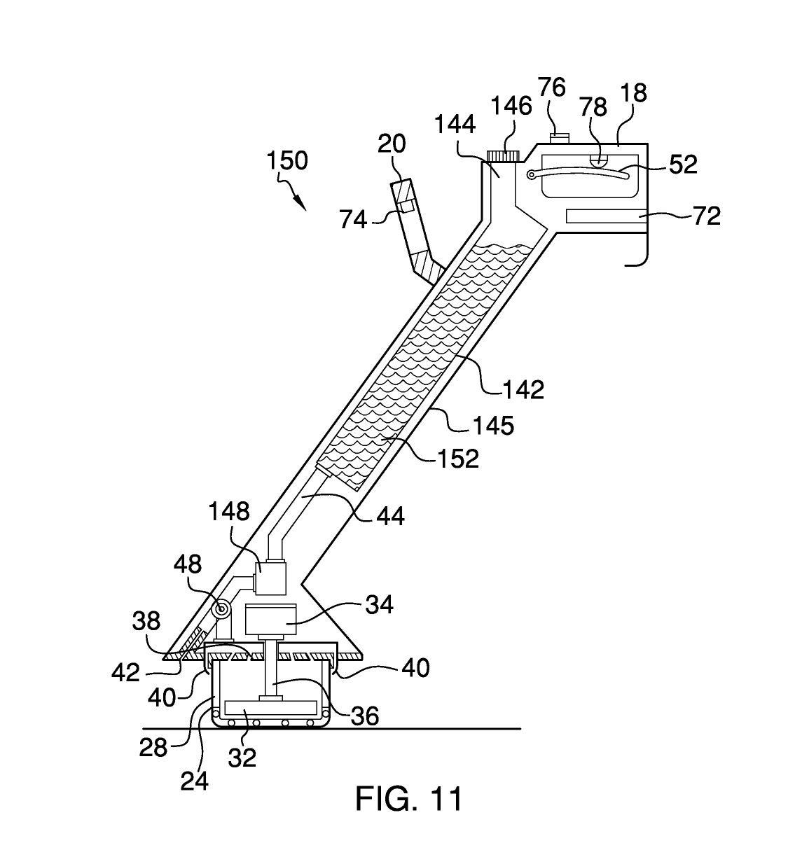

In FIG. 11, there is diagrammatically illustrated a sixth embodiment 150 of the invention, wherein same reference numbers refer to similar parts. The sixth embodiment 150 is an alternative to the fifth embodiment 140 illustrated in FIG. 10, wherein the chemical dispenser 54 and the associated components are eliminated, and further wherein the reservoir 142 is preferably filled with a treatment solution 152.

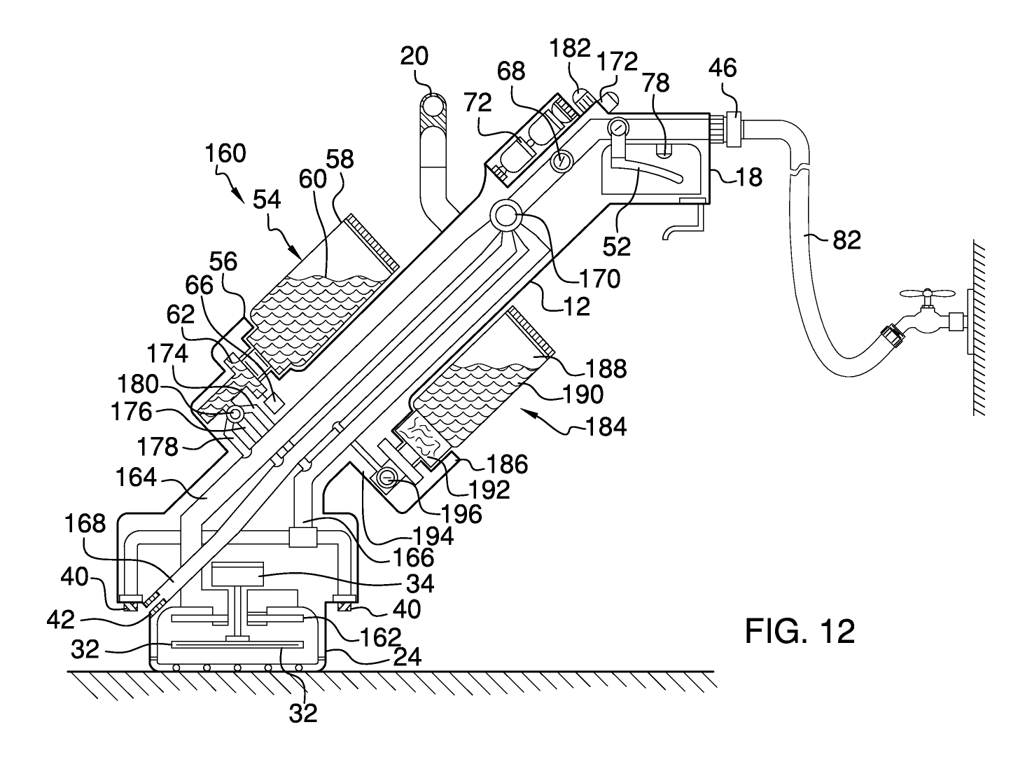

In FIG. 12, there is diagrammatically illustrated a seventh embodiment 160 of the invention, wherein same reference numbers refer to similar parts. In device 160, fluid nozzles 38 are replaced by a rotary spray bar 162 that is rotatably supported by the boom 12 within the plenum 24 and above the material agitator 32. Water jetting from the spray bar 162 causes the spray bar to rotate very similar to a spray bar of a dishwashing machine. The spray bar 162 is fluidically connected to passage 164, nozzles 40 are fluidically connected to passage 166 and nozzle 42 is fluidically connected to passage 168. Passages 164, 166 and 168 are selectively connected to passage 44 by valve 170. Valve 170 is a four-position valve that is operable to selectively and separately connect passages 164, 166 and 168 to passage 44 or to simultaneously connect passages 164 and 166 to passage 44. Valve 170 may be an electrically operated valve and in an aspect a dial selector 172 is operatively connected to valve 170 and power supply 72 to operate the positioning of valve 170 as desired by the operator.

Further in device 160, separate chemical delivery tube or siphon tubes 174, 176, 178 are separately connected to passages 164, 166 and 168, respectively to receive chemical solution 60 from accumulator 62. Valve 180 selectively connects tubes 174, 176 and 178 to the accumulator 62. Valve 180 is a four-position valve having a first position which establishes fluid communication between the accumulator 62 and tube 174, a second position which establishes fluid communication between the accumulator 62 and tube 176, a third position which establishes fluid communication between the accumulator 62 and tube 178, and a fourth position wherein neither of the tubes 174, 176 nor 178 are fluidically connected to the accumulator. Valve 180 may be an electrically operated valve and in an aspect dial selector 182 is operatively connected to valve 180 and the power supply 72 to operate the positioning of valve 180 as desired by the operator.

Device 160 further includes a second chemical dispenser 184. Chemical dispenser 184 includes a cradle 186 disposed along boom 12 and configured to removably receive and retain a container 188 of concentrated chemical solution 190. A fluid accumulator 192 is fluidically connected to the container 188 to receive therein chemical solution 190 when the container 188 is received by the cradle. The container 188 may be fitted with a membrane seal that is pierced by a tube extending from the accumulator 192 to fluidically connect the container and accumulator. Alternatively, a cooperative valve system could be used to fluidically connect the container 188 and the fluid accumulator 192 while preventing spilling of the chemical solution 190 from the container during insertion and removal of the container from the cradle. Essentially, chemical solution 190 within the container 188 flows under the force of gravity into the fluid accumulator 192 when the container is received by the cradle 186 to provide a continuous supply of chemical solution from the container to the accumulator. When the container become empty the container is replaced with a full container.

A delivery tube or siphon tube 194 extends from the accumulator 192 and connects to the fluid passage 168 such that fluid flowing through fluid passage 168 and across the siphon tube draws chemical solution 190 within the fluid accumulator into the fluid passage 168 where it is admix with the fluid flowing therethrough. A supply valve 196 is disposed across the siphon tube 194 or between the accumulator 192 and siphon tube and is operated to control the flow of chemical solution 190 from the accumulator 192 into the fluid passage 166. Valve 196 may be an electrically operated valve and in an aspect is operatively connected to dial selector 182 and power supply 72 for operation thereof. Chemical solution 190 may include a detergent, insecticide, fertilizer or other chemical concentrate solution as desired.

The operation of device 160 is very similar to the operation of any of the embodiments described above and a skilled artisan, upon reading this disclosure, will readily appreciate and understand the operation this embodiment.

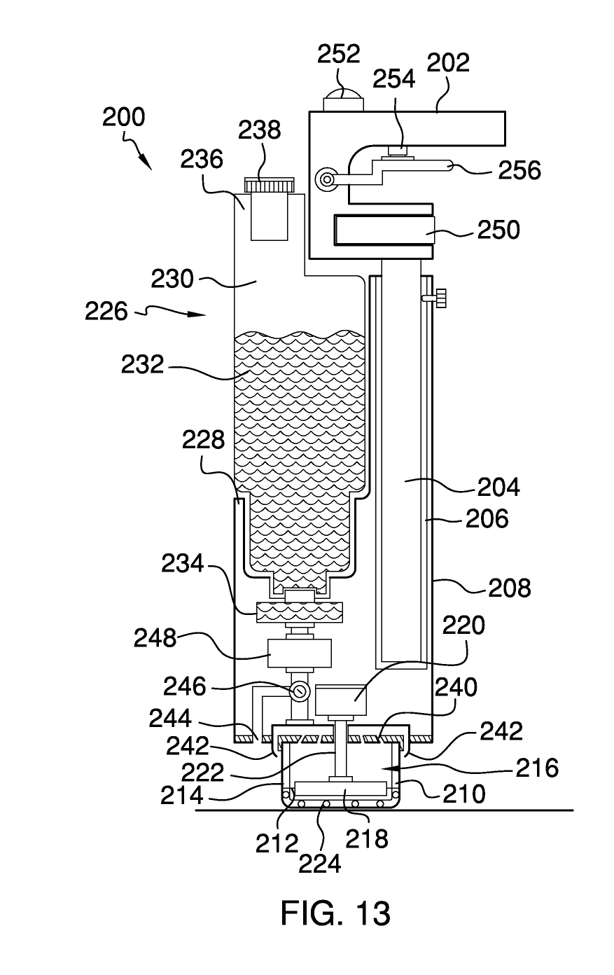

In FIG. 13, there is diagrammatically illustrated another embodiment 200 of the present invention. Device 200 includes a handle 202 having a tubular member 204 extending therefrom. The tubular member 204 is telescopically received by a corresponding tubular shaped opening 206 in housing 208. Tubular member 204 may be extended and retracted into opening 206 to extend and retract handle 202 respective to the housing 208. A plenum 210 depends from an end of the housing 208 that is opposite from handle 202. The plenum 210 includes has an open bottom 212 and a sidewall 214 that defines an interior space 216. The interior space 216 is accessed through the open bottom 212. A material agitator 218 is disposed within the interior space 216. An electric motor 220 supported by the housing 208 is operatively connected to the agitator 218 by shaft 222. The electric motor 220 is operatively connected to the agitator 218 such that operation of the electric motor drives the agitator in an alternating clockwise and counterclockwise rotation. As will be described in further detail below, the plenum 210 is positioned over a deposit of animal waste and serves to shield the operator from animal waste being churned and broken-up by the agitator 218 acting upon the animal waste.

A plate 224 of open mesh grating extends across the open bottom 212 of plenum 210. The open mesh grating plate 224 prevents large solid objects from entering the interior space 216 of the plenum 210 that could possibly damage the agitator 218. The mesh size of plate 224 is sufficient to permit the passage of animal waste into the interior space 216 without mashing the pet waste into the ground. Plate 224 can be removably attached to the plenum 210 by mutual engagement between periphery of the plate and sidewall 214 of the plenum.

Device 200 further includes a chemical dispenser 226. Chemical dispenser 226 includes a cradle 228 formed in housing 208 and configured to removably receive and retain a container 230 of concentrated chemical solution 232. A fluid accumulator 234 is fluidically connected to the container 230 to receive therein chemical solution 232 when the container 230 is received by the cradle. The container 230 may be fitted with a membrane seal that is pierced by a tube extending from the accumulator 234 to fluidically connect the container and accumulator. Alternatively, a cooperative valve system could be used to fluidically connect the container 230 and the fluid accumulator 234 while preventing spilling of the chemical solution 232 from the container during insertion and removal of the container from the cradle. Essentially, chemical solution 232 within the container 230 flows under the force of gravity into the fluid accumulator 234 when the container is received by the cradle 228 to provide a continuous supply of chemical solution from the container to the accumulator. When the container become empty the container is replaced with a full container.

Container 230 may include an opening 236 to permit filing of the container with a pre-mixed chemical solution 232. A lid 238 is cooperatively engagable with container 230 to seal opening 236.

Device 200 further includes a plurality of fluid nozzles 240, 242 and 244. Fluid nozzles 240 are disposed may be disposed within the plenum 210 and arranged to direct fluid jets towards the open bottom 212 and across the agitator 218. Fluid nozzles 240 can be arranged to provide a crossing pattern of jets to impinge upon the animal waste at different angles to further aid in breaking up the waste and/or directed towards the interior surface of sidewall 214 to flush the interior surface free of waste. Fluid nozzles 242 are disposed and arranged to direct fluid jets towards the exterior surface of sidewall 214 to flush the exterior surface free of waste. Fluid nozzle 244 is directed outwardly from the end of housing 208 and away from the plenum 210 to provide a fluid jet that may be used to flush a ground surface. Fluid nozzles 240, 242 and 244 are fluidically connected to nozzle selector valve 246. An electrically operated pump 248 is connected to nozzle selector valve 246 and the accumulator 234 and is operated to pump chemical solution 232 from the accumulator to nozzles 240, 242 and 244. Valve 246 is operated to simultaneously connect nozzles 240 and 242 to the pump 248 or to connect nozzle 244 to the pump. Valve 246 may be an electrically operated valve.

The device 200 further includes a power supply, such as a rechargeable battery pack 250 to provide electrical power to the electrical components of the device. The battery pack 250 can be removably received and retained by the housing 208.

In an aspect, valve 246 is operated and connected to the power supply 250 by an electric switch 252. In an aspect, the electric pump 248 and the electric motor 220 are each operated and connected to the power supply 250 by an electric switch 254. Electric switch 254 may be positioned on handle 202 and operated by trigger 256 by an operator grasping the handle.

The operation of device 200 is very similar to the operation of any of the embodiments described above and a skilled artisan, upon reading this disclosure, will readily appreciate and understand the operation this embodiment.

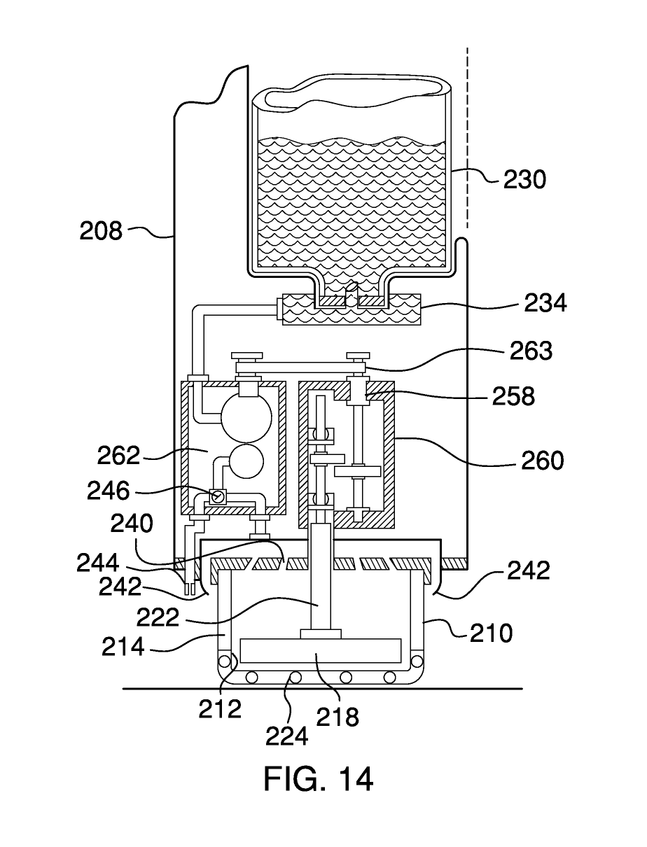

In FIG. 14, there is diagrammatically illustrated an alternative embodiment of device 200, wherein the same reference numbers refer to similar parts. Here, an electric motor 258 is operatively coupled to shaft 222 by a gearbox 260 or similar motion transfer device. Further the electric motor 258 is operatively connected pump 262 to drive the pump during operation of the electric motor. The pump 262 and the electric motor 258 may be operatively connected together in an suitable fashion that permits the electric motor to drive the pump. In a non-limiting example, the pump 262 and the electric motor 258 may be operatively connected by a drive belt 263. Alternatively, the pump may be electrically operated and the shaft 222 may be operatively connected to the pump to drive the shaft.

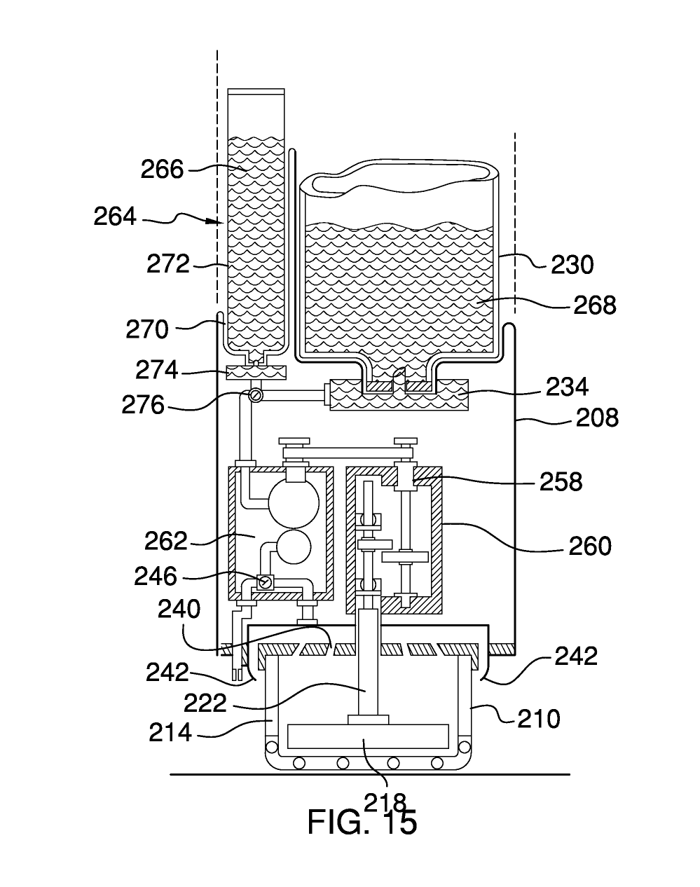

In FIG. 15, there is diagrammatically illustrated an alternative embodiment of device 200, wherein same reference numbers refer to similar parts. Here, the container 230 is filled with freshwater or makeup water 268 and the device 200 further includes a concentrated chemical dispenser 264 for dispensing a concentrated chemical solution 266 for admixing with water 268. Chemical dispenser 264 includes a cradle 270 formed in housing 208 and is configured to removably receive and retain a container 272 of concentrated chemical solution 266. A fluid accumulator 274 is fluidically connected to the container 272 to receive therein chemical solution 266 when the container 272 is received by the cradle. The container 272 may be fitted with a membrane seal that is pierced by a tube extending from the accumulator 274 to fluidically connect the container and accumulator. Alternatively, a cooperative valve system could be used to fluidically connect the container 272 and the fluid accumulator 274 while preventing spilling of the chemical solution 266 from the container during insertion and removal of the container from the cradle. Essentially, chemical solution 266 within the container 272 flows under the force of gravity into the fluid accumulator 274 when the container is received by the cradle 270 to provide a continuous supply of chemical solution from the container to the accumulator. When the container becomes empty the container is replaced with a full container.

Valve 276 is fluidically connected to accumulator 234 and accumulator 274 and is operable to selectively connect the accumulators 234 and 274 to pump 262. In one position, valve 276 simultaneously connects accumulator 234 and 274 thereby permitting mixing of the chemical concentrate solution 266 with the fresh water 268. In a second position, valve 276 only connected accumulator 234 to pump 268. Valve 276 may be an electrically operated valve and an electric switch (not shown) may be provided to operate the valve and to connect the valve to the power supply 250.

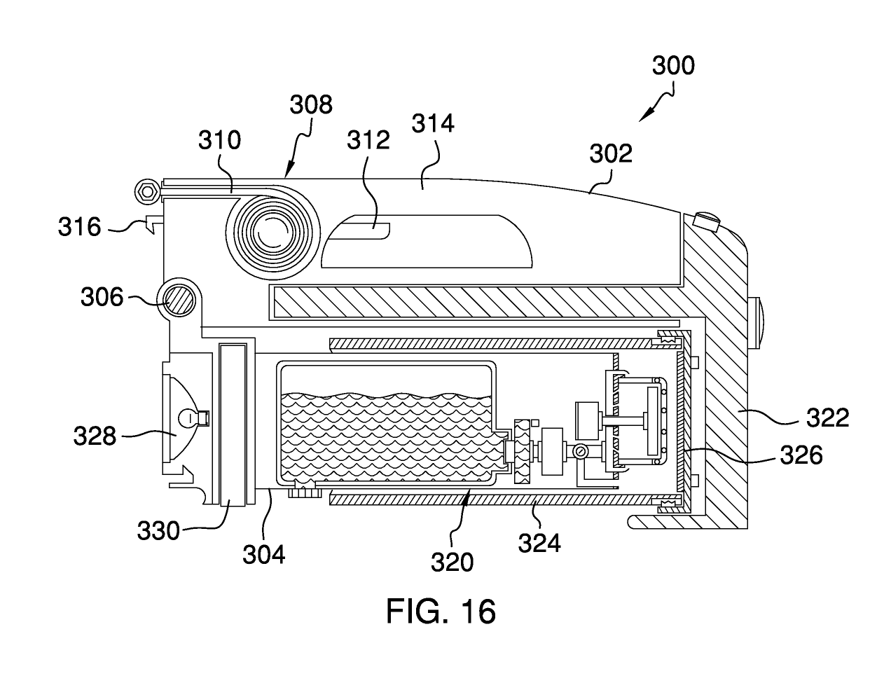

In FIGS. 16 through 18, there is diagrammatically illustrated another embodiment 300 of the invention. Device 300 embodies an animal waste cleaning device 320 of any one of the number of embodiments described above in combined with a retractable leash 308 to provide convenience to a pet owner in the curbing of their pet during a walk.

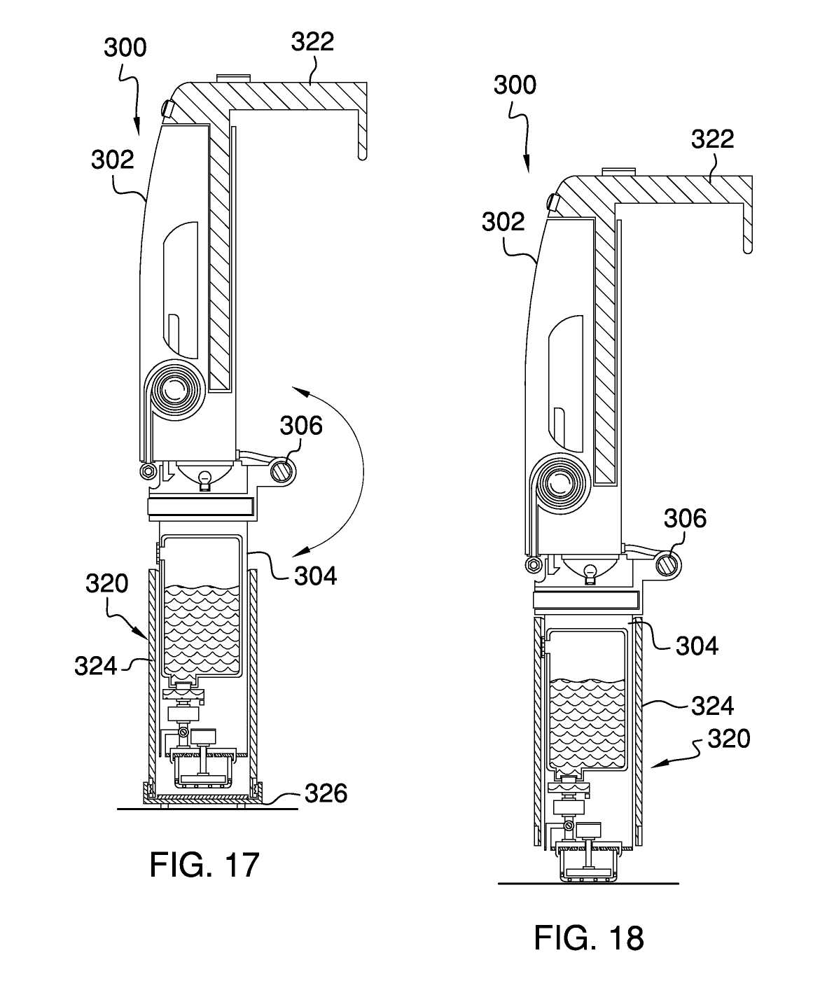

Device 300 includes a first and second body housings 302 and 304 that are rotatably connected together at one end by pivot coupling 306 such that the opposite ends can be rotated towards and away from another between a first position where the body housings are generally disposed side-by-side (FIG. 16) and a second position where the body housings are generally disposed end-to-end (FIGS. 17 and 18). Body housings 302 and 304 may locked together in the end-to-end position by a latch 316. A conventional retractable leash assembly 308 is carried by body housing 302 and includes a retractable leash 310, a leash control lever 312 and grip 314. Retractable animal leashes are well known in the art and thus a detailed explaining of the construction and operation of the same is not necessary.

The waste cleaning device 320 is carried by second body housing 304 and arranged such that when the body housings 302 and 304 rotated into the end-to-end position the cleaning head of the waste cleaning device is orientated in a direction opposite from a handle 322 extending from body housing 302. Handle 322 may be telescopically received by body housing 302 such that it can be extended and retracted therein to extend the user's reach. A sheath 324 is slidably engages with and encircles body housing 304 and is slidable between an extended position where the sheath encloses the cleaning head of the waste cleaning device 320 (FIG. 17) and a retracted position where the cleaning head is exposed (FIG. 18). Further, a removable cover 326 may be provided and cooperatively engaged with the sheath 324 to completely enclose the cleaning head when not being used. Further, handle 322 may further serve to shield and support body housing 304 when in the collapsed side-by-side position. A lamp 328 may be provided to on a front end (when collapsed) of body housing 304 providing a light during use at night. Further a power supply 330 is provided to an connected in any manner as described above to power the electrical components of the cleaning device 320.

A number of embodiments of the present invention have been described. Nevertheless, it will be understood that various modifications may be made without departing from the spirit and scope of the invention.

1. An apparatus for removing animal waste from a surface, comprising:
a boom configured to be grasped by an operator at one end;
a cleaning head attached said boom, said cleaning head having a plenum with an open bottom, said open bottom facing in a direction away from said boom;
a material agitator disposed within said plenum;
an agitator driving motor connected to said material agitator and operable to alternately drive said material agitator in a clock-wise and counter clock-wise direction;
a fluid passage extending said boom and configured to be connected to a supply of pressurized fluid;
a plurality of first fluid nozzles arranged along said plenum, each of said first fluid nozzles configured to jet fluid flowing through said fluid passage towards said open end of said plenum;
a plurality of second fluid nozzles arranged along said plenum, each of said second fluid nozzles configured to jet fluid flowing through said fluid passage towards an exterior wall surface of said plenum;
a third fluid nozzle disposed adjacent to said plenum and configured to jet a fluid flowing through said fluid passage in a direction outwardly and away from said boom and said plenum; and
a fluid nozzle selector valve disposed across said fluid passage and operable to selectively and fluidically connect said first fluid nozzles and said second fluid nozzles concurrently to said fluid passage or said third fluid nozzle to said fluid passage.

2. The apparatus of claim 1, further comprising:
a chemical dispenser fluidically connected to said fluid passage and operating to admix a chemical concentrate with fluid flowing through said fluid passage; and
wherein said apparatus operates in one mode of operation where fluid flows through said fluid passage without chemical concentrate admixed with the fluid flowing through said fluid passage and in a second mode of operation where chemical concentrate is admixed with the fluid flowing through said fluid passage.

3. The apparatus of claim 2, further comprising:
a main valve disposed across said fluid passage at an upstream location;
a control lever operatively connected to said main valve and operating to open or close said main valve to control the flow of fluid through said fluid passage, said control lever disposed to be grasped by an operator while grasping said boom.

4. The apparatus of claim 3, wherein said chemical dispenser includes:
a container fluidically connected to said fluid passage at a position downstream of said main valve; and
a chemical supply valve operating to control the flow of a chemical concentrate from said container and into said fluid passage.

5. The apparatus of claim 4, further comprising:
a fluid sensor operating to sense the presence of a chemical concentrate within an accumulator of said chemical dispenser; and
a cut-off valve disposed across said fluid passage at a downstream location from said main valve and at an upstream location from said fluid connection between said container and said fluid passage, said cut-off valve operating to close and prevent a flow of fluid through said fluid passage upon said fluid sensor detecting no chemical concentrate.

6. The apparatus of claim 5, wherein said fluid nozzle selector valve is an electrically operated valve.

7. The apparatus of claim 5, fluid nozzle selector valve is a manually operated valve.

8. The apparatus of claim 7, further comprising:
a valve control lever; and
a shaft extending along said boom, said shaft operably connected at a first end to said fluid nozzle selector valve and operative connected at a second end to said valve control lever.

9. The apparatus of claim 2, further comprising:
a storage dock having an opening configured to receive a lower end of the boom and said cleaning head and to retain said boom in a generally vertical orientation.

10. The apparatus of claim 9, further comprising:
a liner removably received by said opening of said storage dock.

11. The apparatus of claim 9, wherein said storage dock further comprises:
a battery charging circuit for charging a battery carried by said boom when said boom is received by said opening of said storage dock.

12. An apparatus for removing animal waste from a surface, comprising:
a boom configured to be grasped by an operator at one end;
a cleaning head attached said boom, said cleaning head having a plenum with an open bottom, said open bottom facing in a direction away from said boom;
a material agitator disposed within said plenum;
an agitator driving motor connected to said material agitator and operable to alternately drive said material agitator in a clock-wise and counter clock-wise direction;
a fluid reservoir contained by said boom;
a fluid passage extending said boom;
a fluid pump connecting said fluid reservoir and said fluid passage, and operating to pump fluid contained by said fluid reservoir through said fluid passage;
a plurality of first fluid nozzles arranged along said plenum, each of said first fluid nozzles configured to jet fluid flowing through said fluid passage towards said open end of said plenum;
a plurality of second fluid nozzles arranged along said plenum, each of said second fluid nozzles configured to jet fluid flowing through said fluid passage towards an exterior wall surface of said plenum;
a third fluid nozzle disposed adjacent to said plenum and configured to jet a fluid flowing through said fluid passage in a direction outwardly and away from said boom and said plenum; and
a fluid nozzle selector valve disposed across said fluid passage and operable to selectively and fluidically connect said first fluid nozzles and said second fluid nozzles concurrently to said fluid passage or said third fluid nozzle to said fluid passage.

13. The apparatus of claim 12, further comprising:
a chemical dispenser fluidically connected to said fluid passage and operating to admix a chemical concentrate with fluid flowing through said fluid passage.

14. The apparatus of claim 13, wherein said chemical dispenser includes:
a container fluidically connected to said fluid passage at a position downstream of said main valve; and
a chemical supply valve operating to control the flow of a chemical concentrate from said container and into said fluid passage.

15. An apparatus for removing animal waste from a surface, comprising:
a housing;
a handle having a tubular member extending therefrom that is telescopically received by a corresponding tubular opening through said housing between extended and retracted positions;
a plenum depending from said housing at an end opposite of said handle, said plenum having an open bottom and a sidewall creating an interior space accessible through said open bottom;
a material agitator disposed within said plenum;
an electric motor supported by said housing and being operatively connected to said material agitator;
a fluid dispenser comprising a container removably received and retained by a cradle disposed on said housing and a fluid accumulator receiving fluid contained by said container when received by said cradle;
a pump fluidically connected to said fluid accumulator and operating to pump fluid therefrom;
a plurality of first fluid nozzles arranged along said plenum, each of said first fluid nozzles configured to jet fluid flowing through said fluid passage towards said open end of said plenum;
a plurality of second fluid nozzles arranged along said plenum, each of said second fluid nozzles configured to jet fluid flowing through said fluid passage towards an exterior wall surface of said plenum;
a third fluid nozzle disposed adjacent to said plenum and configured to jet a fluid flowing through said fluid passage in a direction outwardly and away from said boom and said plenum; and
a fluid nozzle selector valve connected to said pump and operable to selectively and fluidically connect said first fluid nozzles and said second fluid nozzles concurrently to said pump or said third fluid nozzle to said pump.

16. The apparatus of claim 15, wherein said container contains a quantity of chemical solution.

17. The apparatus of claim 15, wherein said electric motor is operatively connected to said pump and operates to drive said pump.

18. The apparatus of claim 15, further comprising:
a concentrated chemical dispenser having a chemical concentrate container holding a quantity of concentrated chemical solution removably received and retained by a second cradle disposed on said housing and a second fluid accumulator receiving said concentrated chemical solution when said a chemical concentrate container is received by said second cradle; and
a valve fluidically connected to said fluid accumulator, said second fluid accumulator and said pump, said valve operating to selectively and fluidically connect said fluid accumulator and said second fluid accumulator concurrently to said pump or said fluid accumulator to said pump.

19. The apparatus of claim 15, wherein:
said housing includes first and second body housings that are rotatably connected together at one end by a pivot coupling such that opposite ends are rotatable in a direction towards and away from one another between a first position wherein said first and second body housings are generally disposed side-by-side and a second position wherein said first and said second body housing are generally disposed end-to-end; and
said plenum being carried by said second body housing and said handle being carried by said first body housing such that when said body housings are in said second position said plenum is oriented in a direction away from said handle.

20. The apparatus of claim 19, further comprising:
a sheath slidably disposed on said second body housing between an extended first position wherein said plenum is covered by said sheath and a retracted second position wherein said plenum is not covered by said sheath.

21. The apparatus of claim 19, further comprising:
a retractable leash carried by said first body housing;
a leash control lever; and
a hand grip.
